(19) United States
(12) Patent Application Publication
(10) Pub. No.: US 2017/0105570 A1
(43) Pub. Date: Apr. 20, 2017

(54) STACKING DEVICES

(71) Applicant: Mark Harris, (US)

(72) Inventors: Mark Harris, Charlotte, NC (US); Ulrich Bernd Schnacke, Weddington, NC (US); Dov Z. Glucksman, Winchester, MA (US); Michael Miller, Tewksbury, MA (US); Andrew Rojee, Norfolk, MA (US); Chi Kin John Mak, Wan Chai (CN); CY Ma, Quarry Bay (CN)

(73) Assignee: Mark Harris, Charlotte, NC (US)

(21) Appl. No.: 15/297,678

(22) Filed: Oct. 19, 2016

Related U.S. Application Data
(60) Provisional application No. 62/243,200, filed on Oct. 19, 2015.

(51) Int. Cl. A47J 36/34; F16M 11/24

(52) U.S. Cl. CPC A47J 36/34; F16M 11/24

(57) ABSTRACT

Stacking devices for similarly shaped and/or sized items, for example cookware such as lids, frying pans, sauce pans, and the like, are disclosed. The stacking devices have a frame with leg elements in areas where the side portions of the frame intersect. In a preferred embodiment, the leg elements are selectively oriented to a vertical direction or a horizontal direction. The stacking devices are self-centering in use.

### RELATED APPLICATION

This application claims benefit of U.S. Provisional Application Ser. No. 62/243,200 filed Oct. 19, 2015, entitled “Lid Stacking Device”, which is incorporated herein by reference in its entirety.

### FIELD OF THE INVENTION

Stacking devices of the invention, for example for lids, cookware, and other similarly shaped and sized items, are positioned between the items during use or storage to provide a balanced supporting and stabilizing platform. When used during storage, the stacking devices provide for organization of multiple items and, thus of storage space, to provide for more efficient and safe use of storage space.

### BACKGROUND OF THE INVENTION

Cookware, such as lids, frying pans or skillets, sauce pans and the like are hard to store and are usually in disarray through the continual use involving putting them into and taking them out of a cabinet or other storage area. Additionally, such disarray and moving of cookware in and out of storage can result in scratching, scrapping or other damage to the surface of the cookware, especially glass lids, since the metal of the cookware vessels, handles, lids, etc. hit and rub against each other.

Further, the disarray of cookware often results in lids or pans falling on top of each other or out of a cabinet when a particular piece of cookware is removed from the storage area. This can result in a safety issue, especially if the cookware is stored in a high location.

Accordingly, a device to provide support and stability to cookware or other similarly sized and shaped items in use and storage is desirable. Especially beneficial is a device which is simple in use, e.g., does not require assembly and is self-positioning in use.

Further, a stacking device which is versatile in use is beneficial, e.g., can be used with cookware in use of the cookware as well as during non-use (e.g., storage).

### SUMMARY OF THE INVENTION

The invention involves a stacking device for storing cookware, e.g., lids, frying pans or skillets, sauce pans, roasters, etc., and other items of similar sizes and shapes, as well as can serve as support during use of cookware, for example, to provide a double boiler.

The stacking device is structured to be self-supporting (i.e., self-orienting or self-positioning) and balanced so as to provide a stabilized and rigid support for stacked items. In addition to strength and balance, the stacking device of the invention is adapted to be used with cookware lids having differently sized and shaped knobs or handles (e.g., round or elongated, thick or thin, etc.).

The stacking device of the invention includes a frame including three side portions with intersecting areas where one side portion transitions into another side portion, and a leg element at each of the intersecting areas.

A preferred stacking device has a one piece frame with three intersecting areas, wherein each of the three intersecting areas is structured to include a leg element extending outward of the frame in at least a vertical direction, and wherein each intersecting area is equidistantly spaced from each other to provide three side portions in the frame free of a leg element.

The leg elements of the stacking device, preferably are structured or adapted to be present in relation to the frame, more preferably positioned on the frame, so that the leg element can be selectively oriented in a vertical (i.e., an on-end position) or a horizontal direction (i.e., on one side). The leg elements preferably have a length (L) to diameter (D) ratio in a range of about 1.5:1 to about 2.5:1, more preferably a L:D ratio of about 2:1. The leg elements are made of a material which avoids scratching or other damage of another material which it contacts and is of a material which has a certain, at least minimal, compressibility so that the device provides some grip and does not slide on an item which it contacts during use of the device. The device is also of a size and shape which can be used with items, such as cookware lids, with knobs or handles of different shapes and sizes (e.g., round or elongated).

### BRIEF DESCRIPTION OF THE DRAWINGS

The following detailed description of the specific non-limiting embodiments of the invention can be best understood when read in conjunction with the following drawings.

FIG. 1 is a top perspective view of a preferred embodiment of a metal-framed stacking device of the invention, having leg elements oriented in a vertical direction, i.e., in an on-end position.

FIG. 2 is a plan view of the stacking device shown in FIG. 1 with the leg elements oriented in a horizontal direction, i.e., on side position.

FIG. 3A is a side perspective view of the metal-frame stacking device of FIG. 1 (with leg elements oriented vertically) shown in use stacking multiple different sized lids (the lids being upright and shown in dashed lines to better see the orientation of the stacking devices).

FIG. 3B is a side perspective view of the stacking device of FIGS. 1 and 2 shown for stacking a combination of differently sized lids (in an inverted orientation) and different sized pans (the lids and pans being shown in dashed lines). The leg elements of the stacking devices positioned between the lids are in a vertical position as in FIG. 1 and the leg elements of the stacking device positioned between the pans are in a horizontal position as in FIG. 2.

FIG. 4 shows the stacking device of FIG. 2 positioned on the top of the interior bottom surface of a frying pan. This is the position the stacking device will have when stacking another pan thereon for storage, such as shown in FIG. 3B, or to provide a double boiler (i.e., water present in the lower pan to heat a material in a pan situated atop the stacking device).

FIG. 5 shows a combination of frying pans, sauce pan and lid stacked and having a metal-framed stacking device of the invention atop the lid ready for another lid to be stacked thereon.

FIG. 6 shows a plan view of the metal frame of the stacking device of FIGS. 1 and 2 without the leg elements thereon. The three intersecting areas or corner portions which receive the leg elements have a flattened section between the round side portions of the frame.

FIG. 6A is a perspective side view of the corner portion of the metal frame of FIG. 6.

FIGS. 7A-7E show different views of the leg elements of the stacking device of FIGS. 1 and 2. FIG. 7A is a rear view of a leg element. FIG. 7B is a first side view of the leg element (the opposite side view being a mirror image thereof) showing a slit and passage in the leg element. FIG. 7C is a front view of the leg element looking into the slit. FIGS. 7D and 7E show the leg element bent back and opened at the slit and passage to show interior recesses present in the top, side and bottom of the passage in the leg element.

FIGS. 8A and 8B show an optional cap extender which can be attached to either or both ends of the leg element shown in FIGS. 7A-7E to increase the length of the leg element to accommodate an oversized knob or handle or the like.

FIG. 9 shows a perspective view of a second embodiment of the stacking device of the invention wherein the frame and leg elements are a one piece structure configured as an oval along its exterior edge and along its interior edge which provides a central open area. Each end portion of each leg element is of a material having a softer plasticity (durometer) than the remaining material of the leg element.

FIG. 10 shows a top perspective view of a third embodiment of the stacking device of the invention wherein the frame is a one piece plastic structure configured as an oval along its exterior edge and has an interior opening of a modified oval configuration.

FIGS. 11A and 11B show the stacking device of FIG. 10 disassembled and including the frame, upper parts of the leg elements, and lower parts of the leg elements. The first and second parts of the leg elements snap together when placed in mating relationship in an opening of the frame.

### DETAILED DESCRIPTION OF THE INVENTION

The stacking device of the invention provides a balanced support platform which is particularly useful for stacking one or more items on another item or base surface. A preferred stacking use is the stacking of cookware, for example lids, frying pans or skillets, sauce pans, roasters, etc. The stacking of cookware is especially beneficial in the storage of cookware to prevent the disarray caused by the unbalanced seating of cookware on other cookware due to shapes, sizes, knobs and handles, as well as to prevent scratching or other damage to the cookware from the cookware rubbing and hitting against each other when taking an item from the storage area or returning an item to the storage area. The stacking device of the invention is also versatile in function in that it may be used to stack two pans during cooking, for example to provide a double boiler. A supplemental use of the stacking device is as a trivet.

The structure of the stacking device is unique in that when placed on the body of an item, such as a lid or other item which may have some curvature or inclined surface, it is self-supporting or self-orienting due to the three point contact and side configuration. Additionally, due to the three leg elements and three side portions, whether the side portions are linear or curved, a stabilized support platform is provided. A balancing effect is achieved through the structure of the stacking device, even if positioned off-center to an item being stacked.

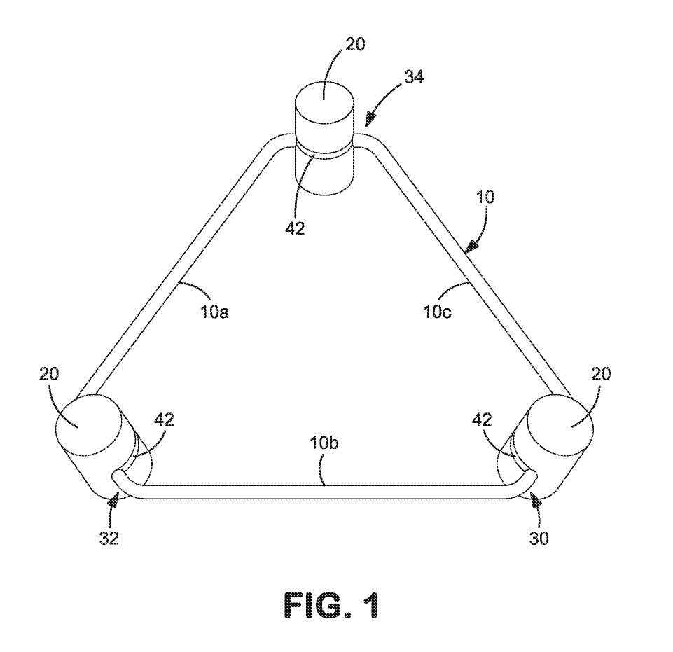

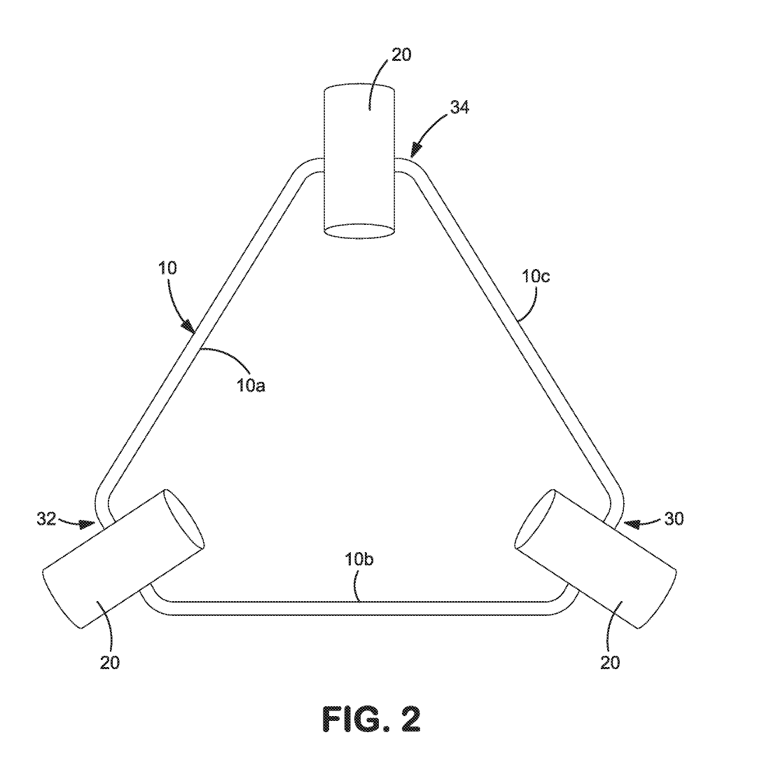

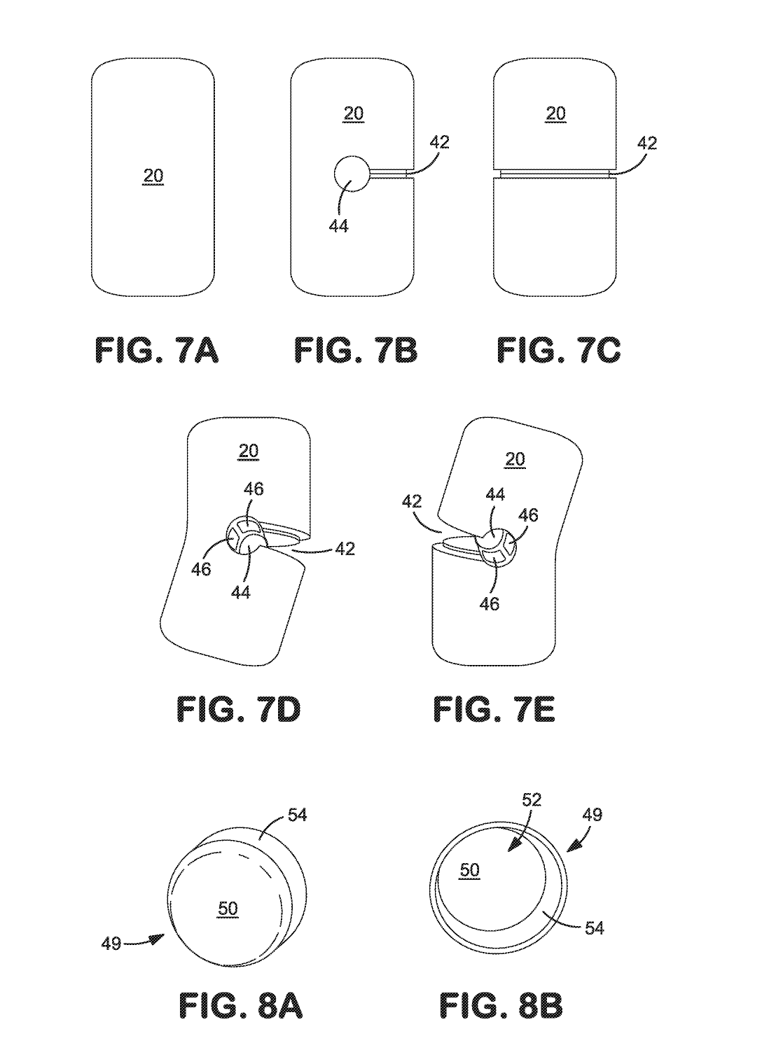

A preferred embodiment of the stacking device of the invention is shown in FIGS. 1-8. The device includes a frame 10 and leg elements 20. FIG. 1 shows leg elements 20 in a vertical or on-end orientation and FIG. 2 shows leg elements 20 in a horizontal or on-side orientation. A benefit of the different orientations and ability to selectively position the leg elements to different orientations is further described below.

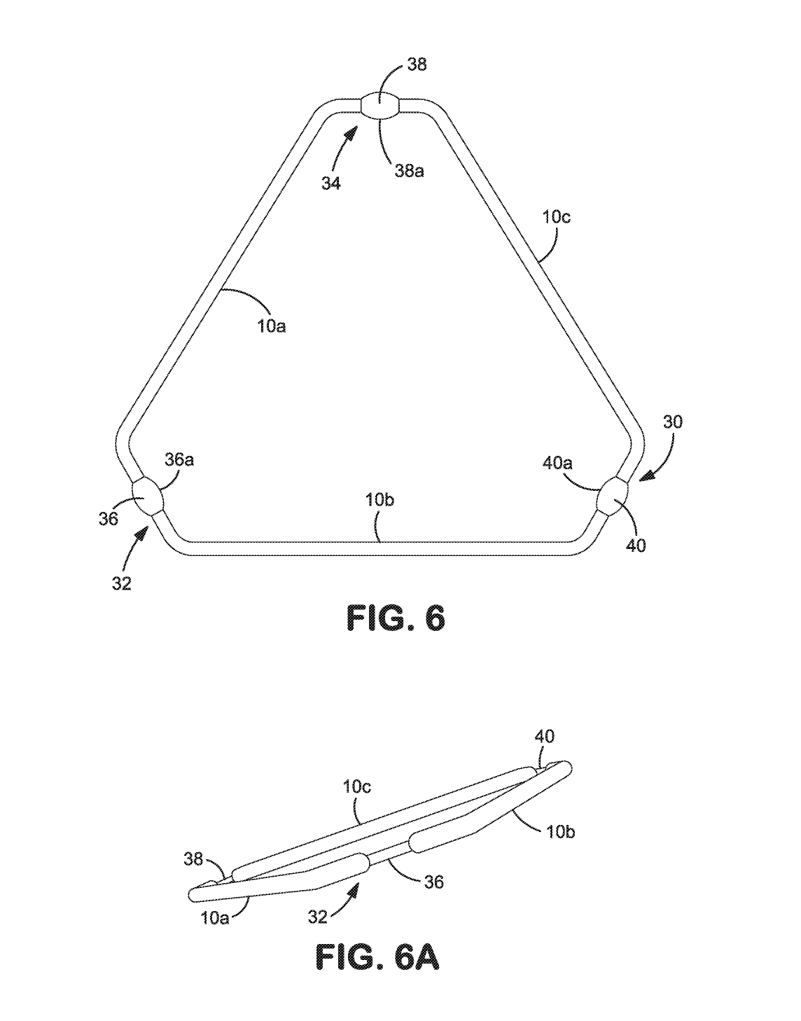

Frame 10 is preferably one piece to provide desired strength and stability. Frame 10 has three side portions 10a, 10b and 10c between leg elements 20. Side portions 10a, 10b and 10c can be linear or curved, but in the more preferred embodiment the side portions are linear. The frame of the embodiment of FIGS. 1 and 2 is shown without leg elements in FIGS. 6 and 6A. In the intersecting areas 30, 32 and 34, where two of leg elements 10a, 10b and 10c meet and form a corner, the leg elements which preferably are round, transition to a flat area 36, 38, 40. Flat areas 36, 38 and 40 preferably extend slightly outward on at least one side of the flat areas 36, 38 or 40 (FIG. 6 shows both sides of flat areas 36, 38 and 40 extending outward) to extend beyond the width or diameter of the side portions 10a, 10b or 10c to provide at least one side extension 36a, 38a and 40a. One leg element 20 is seated in each intersecting area 30, 32 and 34 and is seated therein in a manner to encompass a respective flat area 36, 38 or 40.

The length of the side portions 10a, 10b and 10c extending between the leg elements 20 can be varied so that devices of different sizes can be provided to accommodate support roles for various items. When used in relation to cookware, a size workable with various cookware sizes is side portions having a length within a range of about 11 to about 15 cm, preferably about 12 cm.

Leg elements 20 preferably are substantially cylindrical in shape, see for example FIGS. 1, 2 and 7A-7C. In a preferred embodiment leg elements 20 include a slit 42 which extends through and across approximately the front half and width of a leg element 20 and joins to a cylindrical passage 44 extending through the width of the leg element to provide a continuous open space between the slit and passage in the interior of the leg element. The slit 42 allows for placement of the leg element on a respective intersecting portion 30, 32 or 34 so that the leg element encompasses at least a respective flat portion 36, 38 or 40 and seats the flat portion in passage 44. Inside passage 44 are three recesses 46 sufficient in size to receive, respectively, the side extensions 36a, 38a and 40a of the leg element seated over the corresponding flat section 36, 38 and 40. The combined interaction and seating of extension 36a, 38a or 40a in a recess 46 acts as a detent to retain the leg element in a desired vertical or horizontal orientation on frame 10 and avoid turning or spinning of the leg element 20 on frame 10 during use of the device. These recesses 46 are provided in the top, one side and bottom interior sides of passage 44 in each leg element 20 so that regardless of the direction in which the leg element 20 is turned on the frame 10 to obtain either a vertical orientation or horizontal orientation of the leg element, the extensions 36a, 38a and 40a will sit within a recess 46 to maintain the leg element in the selected orientation.

The frame 10 and leg elements 20 can be made of any suitable material, metal or plastic. The frame 10 should be made of a material which provides a rigidity sufficient to maintain the shape of the frame. In use, the primary force in stacking is exerted on leg elements 20. Examples of suitable materials for frame 10 include metal, plastic, fiberglass, carbon fiber, etc. A preferred material is metal, more preferably stainless steel. The key to a suitable material is that when the material is configured into the frame, the frame is sufficiently rigid to retain the shape of the frame which, in combination with the leg elements, serves to provide the balance or self-centering action of the stacking device of the invention, even if the device is positioned off-center on the item. Support is still provided by the stacking device.

The leg elements 20 are preferably made from a heat stable material, more preferably heat stable up to about 400° F. (204° C.). When the stacking device is used to provide a double boiler, the temperature will not exceed about 212° F. (100° C.). Preferred materials for the leg elements 20 is food grade silicone, and rubber coated with food grade silicone. Alternative materials suitable for use are any material that has a certain plasticity (durometer) so it can hold another item, such as a lid, has a certain degree of suppleness to provide a gripping action, and a certain compressibility so as to achieve a better seat on an item upon stacking of items. The material has to have adequate strength under compression. The degree of compressibility generally is about or less than ½% of the compressibility of the material used to make the leg element (as compared to a sponge material which generally has about 50% compressibility).

Examples of suitable plastic are polyethylene, polypropylene, and polyethylene terephthalate (PET). High density polyurethane can also be used.

The size of the leg elements is important in relation to the length (L) to diameter (D) ratio in order to insure good strength and stability. The L:D ratio of the leg element can be in a range of about 1.5:1 to about 2.5:1 with a preferred L:D ratio being about 2:1. A preferred leg element has a length of about 40 mm and a diameter of about 20 mm. These measurements can be adjusted to be maintained with the described L:D ratios.

The leg elements 20 provided on a frame 10 can be provided in a given size, e.g., 40 mm×20 mm, and if needed to be used with a lid having an unexpectedly taller knob or handle, e.g. 1¾ inch in height, an extension for each leg element can be used to increase the length of the leg. A preferred extension structure due to its simplicity in structure and use is in the form of a cap, for example as shown in FIGS. 8A and 8B. The cap is cylindrical in a size complementary to being seated on the top and/or bottom of each leg element 20. The cap 49 has a closed end wall 50, open bottom 52, and circular side wall 54. The cap is made of a material which is also suitable to make the leg element, and preferably is the same material as the leg element. The side wall 54 of the cap 49 will have sufficient flexibility so that the open end 52 can be placed on a top and/or bottom end of a leg element and the cap seated on the end of the leg element by a friction fit.

The cap, as with the leg, is made of a material and structure so as to have a certain compressibility so as to be non-sliding or provide a grip with respect to the item the stacking device is placed on and the item placed on the stacking device. This assists in maintaining the stacking device in place between two surfaces in a stable and non-damaging manner. The extender cap 49 is preferably made of food grade silicone.

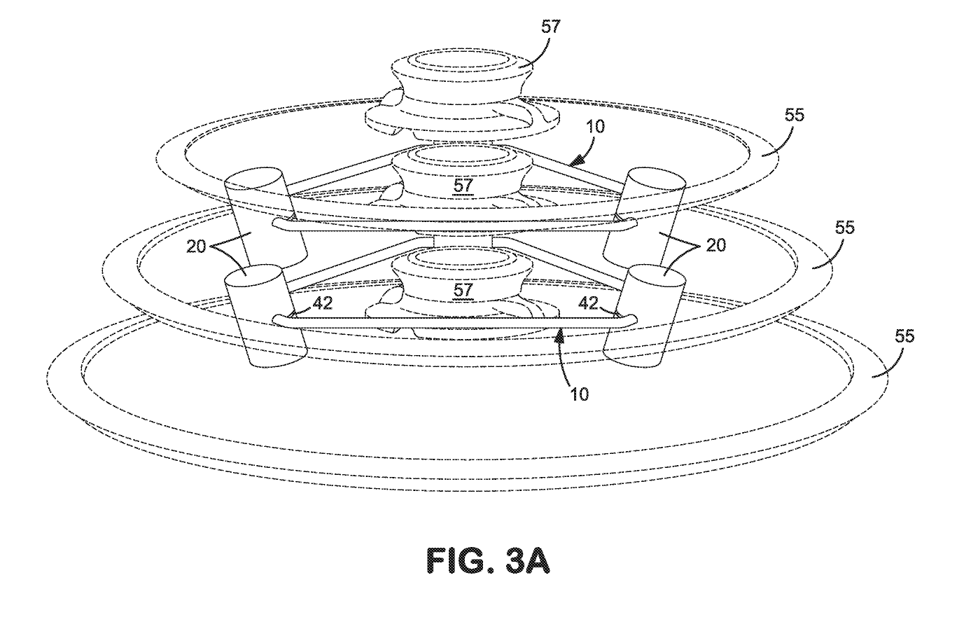

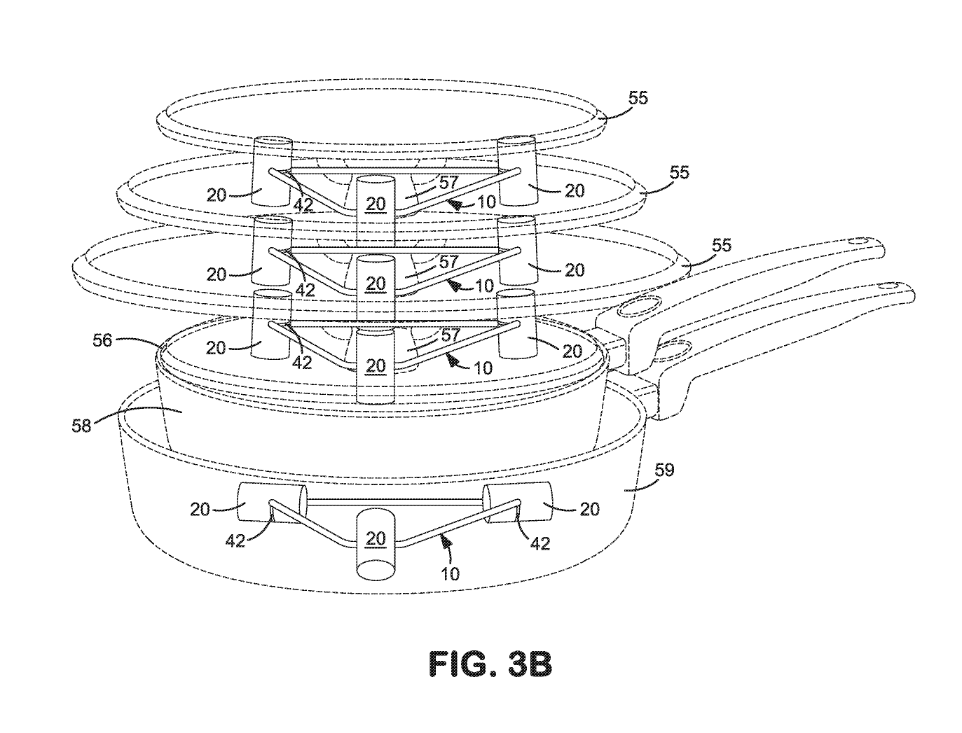

Examples of the preferred metal-framed stacking devices in use are shown in FIGS. 3A, 3B, 4 and 5.

FIG. 3A shows the stacking device with leg elements 20 in a vertical or on-end orientation and positioned between upright lids 55 of varying sizes to provide a stable stack of lids. The lid knobs 57 are positioned in the open center of the stacking devices and the leg elements 20 serve as non-sliding support on both upper and lower lids.

FIG. 3B shows the stacking device with multiple sizes of lids 55 and different sized pans 59. As shown in FIG. 3B, the lids 55 can be stacked in an inverted position so that the lowermost lid 56 extends into the adjacent pan 58 upon which it is supported by the top of the pan side walls. No stacking device is, thus, required in pan 58. The stacking device situated between the two pans 58 and 59 has the leg elements 20 oriented in a horizontal direction or on-side to provide a lower and more stable stacking profile without damage to surfaces of the pans.

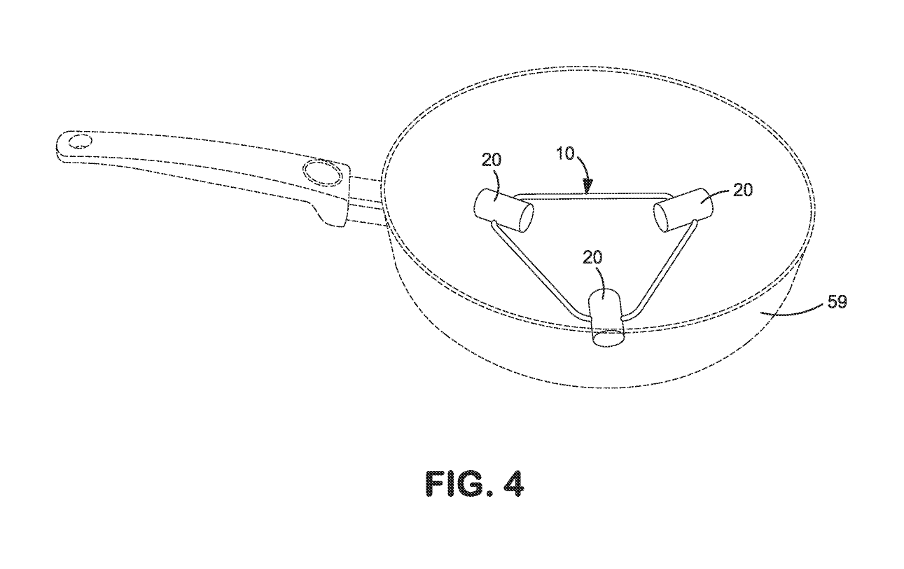

FIG. 4 shows the stacking device in position as in FIG. 3B for stacking pans 59 together. This arrangement in FIG. 4 can also be used to provide a double boiler. The pan 59 containing the stacking device can be filled with water and a sauce pan placed on top of the stacking device. The desired food product to be cooked will be in the sauce pan and heated by water in pan 59. As described above, the stacking device is preferably made of material which is heat stable to about 400° F. (204° C.), for example stainless steel for the frame and food grade silicone for the leg elements.

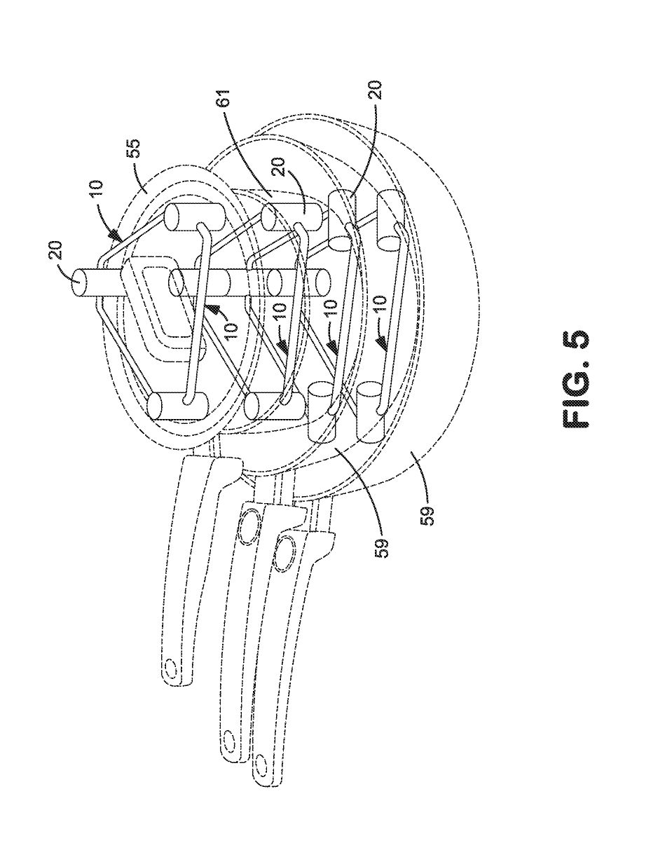

FIG. 5 shows stacking of a combination of frying pans 59, sauce pan 61 and lid 55 with a stacking device on top of the lid to protect the handle of the lid in the open center of the stacking device and ready to receive another item for seating on top of the stacking device. As in the other uses, the leg elements 20 of the stacking device are oriented in a horizontal direction when positioned between pans (frying pans, sauce pans, and the like) and are oriented in a vertical direction when used to stack lids or other objects not having flat surfaces.

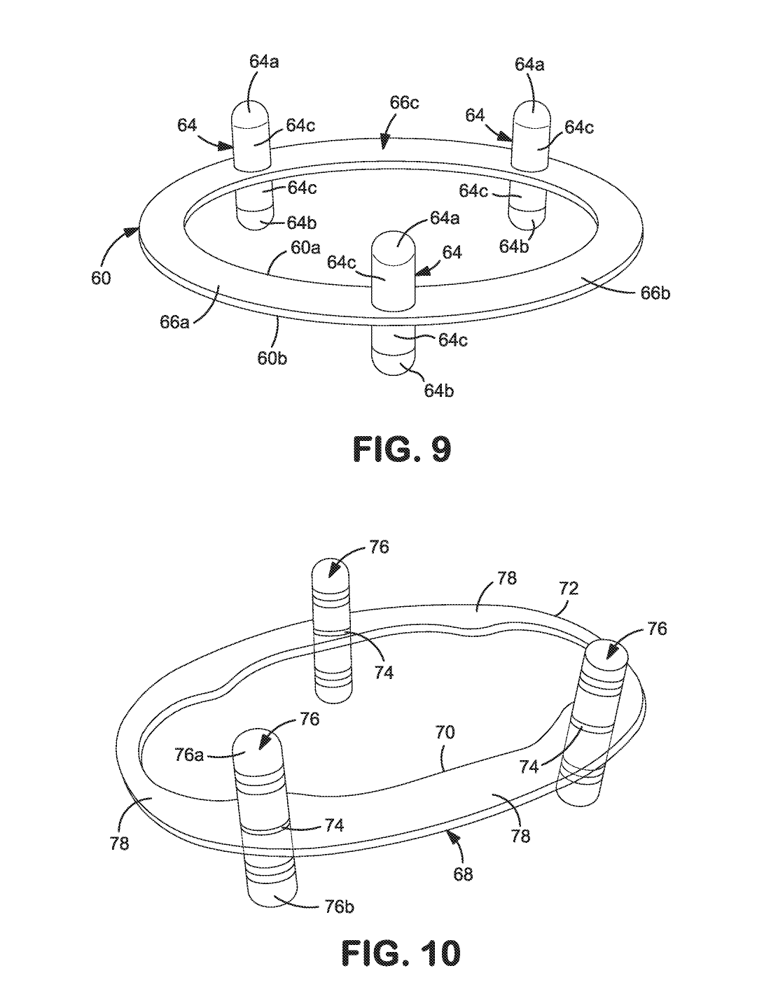

Alternative embodiments to the metal-framed stacking device as described herein, are shown in FIGS. 9, 10, 11A and 11B. These alternative embodiments involve plastic-framed stacking devices. The providing of the frame in plastic, allows the frame to be molded into different desired shapes or configurations.

FIG. 9 shows the frame 60 made of plastic in an oval configuration in both the interior opening provided by interior edge 60a and exterior configuration provided by exterior edge 60b. The frame 60 includes as an integral part thereof three leg elements 64. Leg elements 64 and frame 60 are preferably one piece to achieve the desired stability and support of the plastic-framed stacking device. In between leg elements 64 are curved side portions 66a, 66b and 66c. Leg elements 64 preferably are dome-shaped at each end portion 64a and 64b of each leg element 64. Further, end portions 64a and 64b are preferably of a material having a different, i.e., softer, plasticity (durometer) than the material providing the remaining portion 64c of the leg element. This softer plasticity of the material allows the material to have a better grip to the surface contacted by each end portion 64a and 64b in use of the plastic-framed stacking device. The embodiment of FIG. 9 is used in the same manner as the embodiment of FIG. 1, except that the leg elements are not selectively turn-able to a horizontal direction, but rather is only used in a vertical direction.

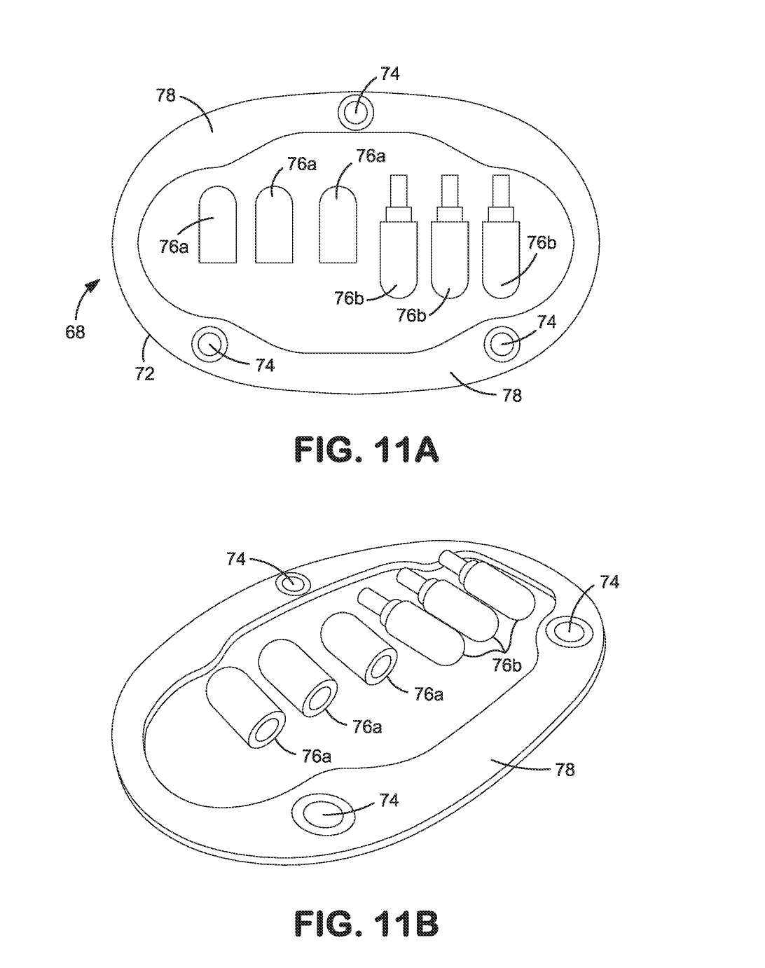

FIGS. 10 and 11A-11B show another alternative embodiment having a frame 68 made of plastic. Frame 68 has an oval configured exterior edge 72, but has a modified oval interior space bounded by interior edge 70. The interior edge 70 configuration provided is useful with lids having elongated handles that require added length or width within the interior open space of the frame. The frame otherwise is similar to the frame of FIG. 9 in that it has three openings 74 for receiving and holding three leg elements 76. In FIGS. 11A and 11B, the frame 68 and leg elements 76 are shown disassembled. The frame 68 is one piece with three openings 74 therein and three curved side portions 78 between openings 74. The leg elements 76 as shown in the embodiment of FIGS. 10 and 11A-11B are formed of two parts, i.e., top part 76a and bottom part 76b, which preferably are matingly structured to snap fit together. Bottom part 76b is inserted into an opening and top part 76a snap fit thereon so as to close the leg parts within and around the opening 74 and provide a stable leg element 76. The leg elements of the alternative embodiment of FIGS. 11A and 11B are not re-orientable between a vertical direction and a horizontal direction.

Each of the embodiments described herein, except the one piece embodiment shown in FIG. 9, can be easily disassembled, if desired, for shipping purposes to provide a lower packaging profile. The metal-framed stacking device, however, can provide a lower packaging profile simply by re-orienting the leg elements into a horizontal direction as in FIG. 2. Thus, the metal-framed stacking device is further advantageous in that it can be provided without requiring any assembly by a user and as requiring only minimal packaging.

The exemplary embodiments herein disclosed are not intended to be exhaustive or to unnecessarily limit the scope of the invention. The exemplary embodiments were chosen and described in order to explain the principles of the present invention so that others skilled in the art may practice the invention. As will be apparent to one skilled in the art, various modifications can be made within the scope of the aforesaid description. Such modifications being within the ability of one skilled in the art form a part of the present invention and are embraced by the appended claims.

We claim:

1. A stacking device comprising a frame including three side portions with intersecting areas where one side portion transitions into another side portion, and a leg element in each of said intersecting areas; wherein said leg element is positioned in relation to said frame at a respective one of said intersecting areas and adapted so that said leg element can be selectively oriented in a vertical direction or a horizontal direction.

2. The stacking device according to claim 1 wherein the leg element has a length to diameter ratio in a range of about 1.5:1 to about 2.5:1.

3. The stacking device according to claim 1 wherein the leg element has a length to diameter ratio is about 2:1.

4. The stacking device according to claim 1 wherein said frame is one piece.

5. The stacking device according to claim 1 wherein each of said intersecting areas has a flat section which transitions to the side portions in said frame.

6. The stacking device according to claim 5 wherein each said leg element is adapted to releasably hold said leg element in said vertical direction or said horizontal direction based on orientation of said leg element on said flat section.

7. The stacking device according to claim 1 wherein said frame is metal.

8. The stacking device according to claim 1 wherein said frame is plastic.

9. The stacking device according to claim 1 wherein said leg element is made of food grade silicone.

10. The stacking device according to claim 1 wherein said frame and said leg element are heat stable to about 400° F. (204° C.).

11. The stacking device according to claim 1 wherein said leg element is composed of a material which has greater than 0 to about ½% compressibility.

12. The stacking device according to claim 1 wherein said frame is substantially triangular in shape.

13. The stacking device according to claim 1 wherein said frame is oval in shape.

14. A stacking device comprising a one piece frame with three intersecting areas wherein each intersecting area is adapted to include a leg element extending outward of the frame in at least a vertical direction, wherein each intersecting area is equidistantly spaced from each other to provide three side portions in said frame free of a leg element.

15. The stacking device according to claim 14 wherein said frame is metal.

16. The stacking device according to claim 14 wherein said frame is plastic.

17. The stacking device according to claim 16 wherein said frame and said leg elements are one piece.

18. The stacking device of claim 17 wherein each end of each of said leg elements includes a dome-shaped end portion comprising a material having a softer plasticity than the plastic forming the leg element.

19. The stacking device according to claim 14 wherein each of said three intersecting areas has a flat section therein.

20. The stacking device according to claim 19 wherein each said leg element can be selectively oriented in a vertical direction or a horizontal direction, and wherein each said leg element is adapted to releasably hold said leg element in said vertical direction or said horizontal direction based on orientation of said leg element on said flat section.

21. The stacking device according to claim 14 wherein each of said three intersecting areas has an opening extending through the frame.

22. The stacking device according to claim 14 wherein said frame is substantially triangular in shape.

23. The stacking device according to claim 14 wherein said frame includes an outer edge which provides the frame with an oval configuration.
